(19) United States
(12) Patent Application Publication
(10) Pub. No.: US 2003/0070008 A1
(43) Pub. Date: Apr. 10, 2003

(54) SYSTEM OPERATING ACCORDING TO A PROGRAM AND ITS FUNCTION SELECTING METHOD

(76) Inventors: TERUAKI KITAGAWA, SHIZUOKA (JP); TAKAHIRO SUZUKI, SHIZUOKA (JP); YASUHIRO ITO, SHIZUOKA (JP); HIDEKAZU MURAMATSU, SHIZUOKA (JP); KEN MIURA, SHIZUOKA (JP)

Correspondence Address: FOLEY & LARDNER, PO BOX 25696, WASHINGTON, DC, 200078696

(21) Appl. No.: 09/393,622

(22) Filed: Sep. 10, 1999

(30) Foreign Application Priority Data
Sep. 10, 1998 (JP) 10-256744

(51) Int. Cl. G06F 13/10

(52) U.S. Cl. 710/8

(57) ABSTRACT

A system for performing various functions according to an installed program, comprises a PLD, installed in a replaceable way, for storing function selecting data indicating kind of each function to be performed by the program, a control circuit for making only a program for performing a function indicated in the function selecting data stored in the PLD into executable state, and a relationship storing circuit for storing relationship between the function selecting data and each function indicated by the same data, the control circuit selecting the function corresponding to the function selecting data of the PLD from the relationship storing circuit and making only the program for performing the selected function into executable state.

### BACKGROUNDS OF THE INVENTION

1. Field of the Invention

The present invention relates to a system that operates according to a program stored in a storage, and more particularly it relates to a function selection method of selecting some specified function, as a function to be performed by the system, from every function provided to the system according to the program.

2. Description of the Related Art

In a system (electronic equipment) having a CPU and operating according to software, a function to be performed by the system is performed by an installed program. In order to add another function, new software including a program for performing the additional function must be installed in the system. In a system with a lot of options, various software must be prepared depending on these options, and at the shipment of the system, it is necessary to select software for performing functions desired by a user before installing the software therein.

It is inconvenient for both a user and a provider (maker) to change the software every time a user requires addition of functions. Further, installation of necessary software selected from various software at the shipment disadvantageously causes a rise in manufacturing cost and managing cost. Accordingly, a method may be used, in which software for performing all the possible functions desired by a user is previously installed in a system before activating only a program for performing a function desired by the user with a switch of hardware. In this case, a system costs so much depending on the number of the functions to be performed.

This method, however, is not the best method, because there is the fear that a user and a sales agent may operate such a switch to activate the other functions than the user's available functions.

In another way, there is a method of storing a program for performing a basic function into a ROM within a system and installing a PLD (Programmable Logic Device) in the system, as disclosed in, for example, Japanese Patent Publication Laid-Open (Kokai) No. Heisei 5-242050. According to the method, programming the PLD may easily perform an additional function.

A provider, however, cannot solve the trouble of installing the software into a system after selecting software for performing a function desired by a user. For example, as for a user desiring additional functions A and B besides the basic function, it is necessary to program a circuit for performing the additional functions A and B, in the PLD, and as for a user desiring additional functions C and D as well as the basic function, it is necessary to program a circuit for performing the additional functions C and D in the PLD.

As mentioned above, in the conventional system operating according to a program, various software for performing various functions must be prepared and combination of the software must be installed therein according to the functions desired by each user. This causes an increase in the cost on a provider side and inconvenience on a user side.

### SUMMARY OF THE INVENTION

An object of the present invention is to provide a system that operates according to a program capable of performing a function desired by each user easily, with no need of change or addition of software or hardware in adding a function, and a function selection method thereof.

Another object of the present invention is to provide a system that operates according to a program capable of easily changing the functions on a provider side and incapable of easily changing a function on a user side, and a function selecting method thereof.

According to the first aspect of the invention, a system for performing various functions according to an installed program, comprises

selecting data storing means for storing function selecting data indicating kind of each function to be performed by the program, and

control means for making only a program for performing a function indicated in the function selecting data stored in the selecting data storing means, into executable state.

In the preferred construction, the function selecting data is data for specifying one of combinations of functions to be performed by the program,

relationship storing means for storing relationship between each function selecting data and each function indicated by the same data is included, and

the control means selects the function corresponding to the function selecting data of the selecting data storing means from the relationship storing means and makes only the program for performing the selected function into executable state.

In another preferred construction, the system further comprises program storing means for storing programs corresponding to all the possible functions to be performed, the control means making only a program for performing a function indicated in the function selecting data, of the programs within the program storing means, into executable state.

In another preferred construction, the system further comprises program storing means for storing programs corresponding to all the possible functions to be performed, the function selecting data being data for specifying one of combinations of functions to be performed by the program; and relationship storing means for storing relationship between each function selecting data and each function indicated by the same data, the control means selecting the function corresponding to the function selecting data of the selecting data storing means from the relationship storing means and making only the program for performing the selected function, of the programs within the program storing means, into executable state.

In another preferred construction, the selecting data storing means is a PLD installed in a replaceable way.

In another preferred construction, the selecting data storing means is a PLD,

program storing means for storing programs corresponding to all the possible functions to be performed is included, and

the control means makes only a program for performing a function indicated in the function selecting data of the PLD, of the programs within the program storing means, into executable state.

In another preferred construction, the selecting data storing means is a PLD having a security bit and installed in a replaceable way.

In another preferred construction, when there arises a request for performing a function, the control means reads out the function selecting data from the selecting data storing means, checks whether the requested function is found in the functions corresponding to the read-out function selecting data, and when the requested function is found there, the requested function is performed, while when it is not found, the requested function is not performed.

In another preferred construction, the system further comprises external storing means for storing programs corresponding to all the possible functions,

the control means loading only a program for performing a function indicated in the function selecting data, of the programs within the external storing means, from the external storing means so to make the program into executable state.

According to the second aspect of the invention, a function selecting method in a system for performing various functions according to an installed program, comprising the steps of:

installing a PLD in which function selecting data indicating kind of each function to be performed by the program is programmed, in a replaceable way; and

selecting a program for performing a function in accordance with the function selecting data of the PLD.

In the above-mentioned construction, the function selecting method further comprises a step of newly installing a PLD in which the function selecting data for specifying the changed function is programmed, when changing the kind of a function to be performed.

In another preferred construction, the function selecting method further comprises a step of installing a control circuit for selecting a program for performing a function in accordance with the function selecting data of the PLD and making the same program into executable state.

In another preferred construction, the function selecting method further comprises a step of installing a control circuit for selecting a program for performing a function in accordance with the function selecting data of the PLD and making the same program into executable state, the method in which

the control circuit

reads out the function selecting data from the selecting data storing means when there arises a request for performing a function and checks whether the requested function is found in the functions corresponding to the read out function selecting data;

when the requested function is found there, the same requested function is performed, while when the requested function is not found, the same function is not performed.

According to another aspect of the invention, a system for performing various functions according to an installed program, comprises

a PLD, installed in a replaceable way, for storing function selecting data indicating kind of each function to be performed by the program; and

a control circuit for making only a program for performing a function indicated in the function selecting data stored in the PLD, into executable state.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the constitution of, by way of example, a private branch exchange operating according to a program of the present invention;

FIG. 2 is an explanatory diagram for use in describing one example of a function comparison table;

FIG. 3 is a flow chart showing the operation of initial setting of a system according to a control unit of the above embodiment;

FIG. 4 is a flow chart showing the operation of inhibiting execution of a function which is not permitted a user according to a control unit of the second embodiment;

FIG. 5 is a block diagram showing another constitutional example of a private branch exchange to which the present invention is applied.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

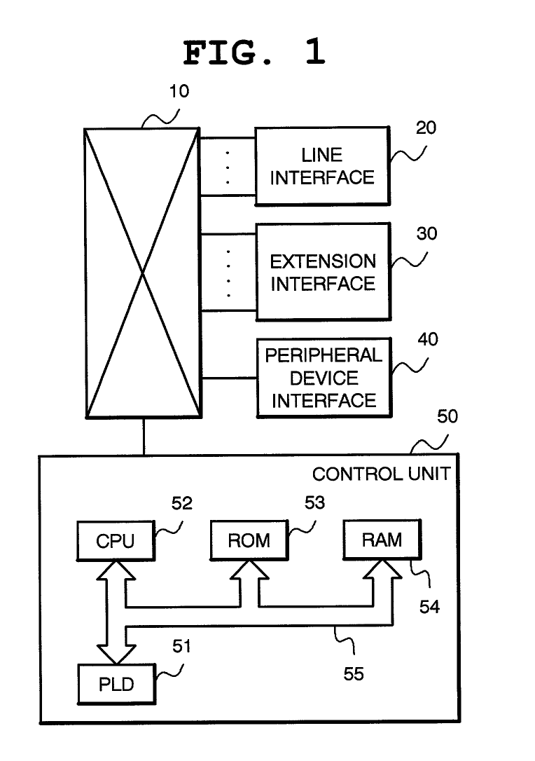

FIG. 1 is a block diagram showing the constitution of, by way of example, a private branch exchange to which a system operating according to a program of the present invention is applied.

In FIG. 1, lines from a public line and another private branch exchange are connected to a switch 10 having a switching function through a line interface 20. Further, a terminal such as a phone is connected to the switch 10 through an extension interface 30. It is also possible to connect a personal computer or the like thereto through a peripheral device interface 40. A control unit 50 for controlling a private branch exchange is connected to the switch 10.

The control unit 50 includes a CPU 52, a ROM 53, a RAM 54, and the like and operates according to a program. The CPU 52 is connected to a PLD 51 through a bus 55. The programs for performing every function that can be served by the private branch exchange are stored in the ROM 53. The functions that can be served by the private branch exchange include, for example, display of calling phone number (international standard), message record, message transfer (international standard), charge account (international standard), optimum line selection (international standard), automatic call distribution, or the like, in addition to the basic switching function.

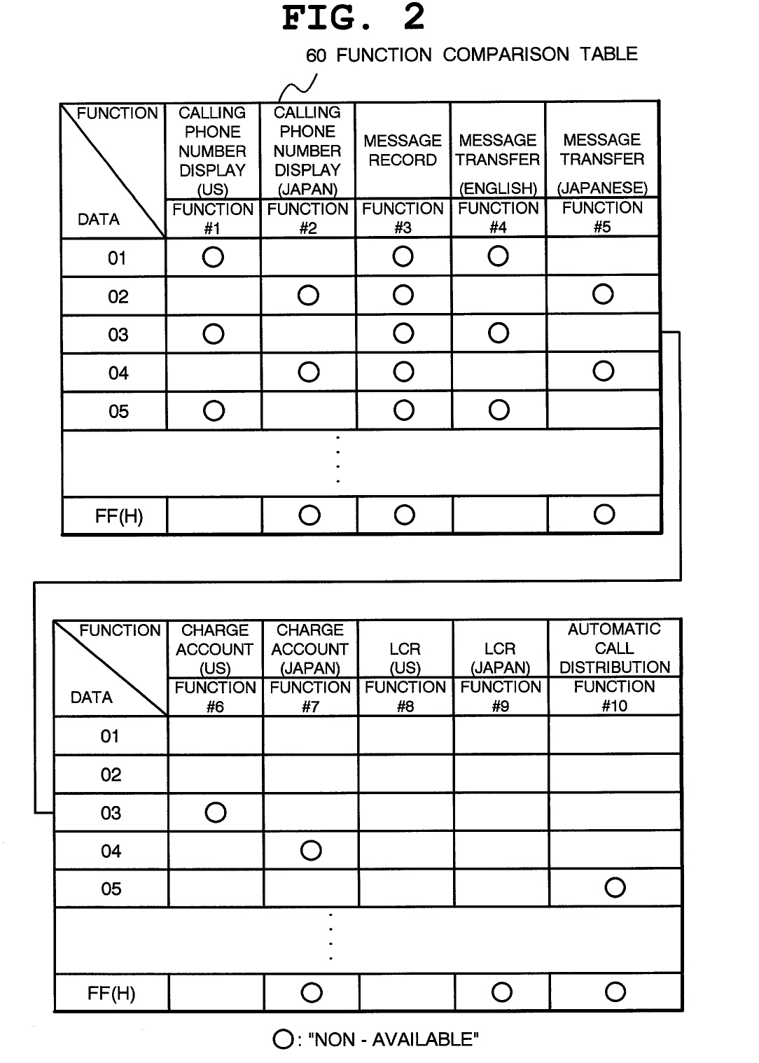

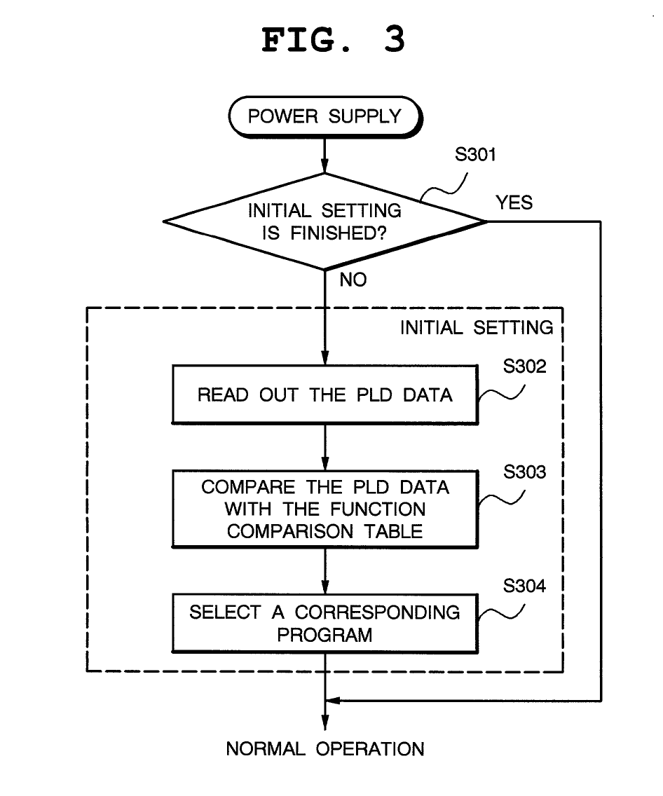

Next, the operation of the initial setting in the above system will be described with reference to the explanatory diagram of FIG. 2 and the flow chart of FIG. 3.

A provider of the private branch exchange shown in FIG. 1 programs the data corresponding to a function desired by a user into the PLD 51. The PLD 51 with the data set there is installed in the system.

For example, as for a user desiring the function #1, #3, and #4 as illustrated in FIG. 2, a logical circuit is constructed in the PLD 51 so as to let the data “01” output from the PLD 51. In other words, the PLD 51 is programmed so as to output the data “01”. As for a user desiring the functions #2, #3, and #5, a logical circuit is constructed in the PLD 51 so as to let the data “02” output from the PLD 51. Further, a security bit is set in the PLD 51 so to prohibit readout of the content of the internal logical circuit in the PLD 51.

In the ROM 53, stored are various programs for performing every function which can be served by the private branch exchange as well as the data of a function comparison table 60 indicating relationship between data and functions as illustrated in FIG. 2. This function comparison table 60 defines combinations of functions to be performed by each program, by every data number.

As mentioned above, when a system provided with the PLD 51 on which some data (data “01”, “02”, . . . , “FF”) of providing functions as shown in the function comparison table 60 is written is in the hand of a user and the power is supplied to the system, the CPU 52 first confirms that the initial setting has been finished (Step S301). If the initial setting has not been finished yet, the CPU 52 runs the initial setting program established in the ROM 53. Namely, the data is read out from the PLD 51 (Step S302). The read out data is compared with the function comparison table 60 (Step S303).

That is, the CPU 52 recognizes each marked function in the corresponding line of the data read out from the PLD 51 (one of the data “01”, “02”, . . . , “FF”), in the function comparison table 60. Then, it activates only the program for performing the recognized function, of the programs for performing functions which are stored in the ROM 53 (Step S304). As an activating method, for example, such a method of writing information indicating whether each program should be activated or not into the nonvolatile RAM 54 before letting a non-activated program out of use, may be considered. Further, another method of neglecting the operation in the case of receiving an input operation for performing the function corresponding to the non-activated program may be considered.

After finishing the above initial setting, the CPU 52 turns into the state of normal operation for performing each function of the private branch exchange.

As mentioned above, each program corresponding to every function that can be served by the private branch exchange is stored in the ROM 53, an internal logical circuit of the PLD 51 is constructed so as to supply the data corresponding to the functions that are permitted a user, and the CPU 52 makes only the program corresponding to the data read out from the PLD 51 into an executable state. Accordingly, there is no trouble of installing the software after selecting necessary software from various software at the shipment, differently from the conventional device.

When an additional function is required, a user has only to replace the PLD 51. For example, when a user who is permitted the functions #1, #3, and #4 shown in FIG. 2 wants to add the function #6, in place of the PLD 51 which has been installed so far, he or she can buy a new PLD 51 programmed so to supply the data “03” and install the same into the system. In the conventional device, the ROM 53 with a program for performing the additional function written therein has been required to be created again; however, the present invention has only to program the PLD 51.

Further, since the security is attached to the PLD 51 at the time of data writing, it is difficult to create a PLD corresponding to the different function through analysis of the content of the PLD 51. Namely, it is very difficult to change the content of a PLD 51 illegally for the purpose of realizing a function different from the functions permitted a user or a function added to the functions permitted a user.

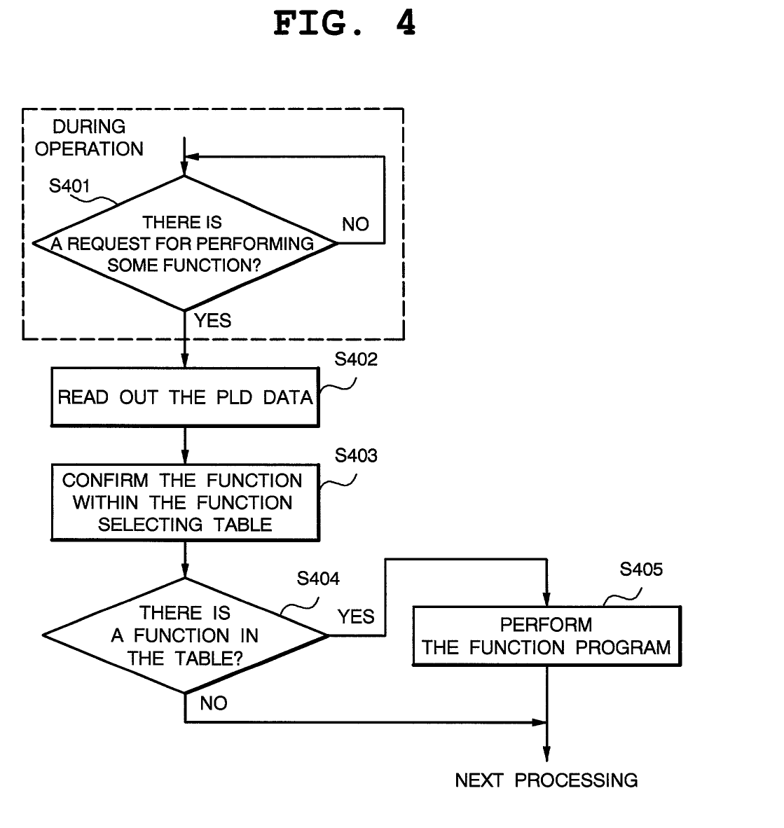

The above-mentioned embodiment has been described by way of example of a private branch exchange for selecting functions to be provided according to the output data of the PLD 51. Further, according to the present invention, it is also possible to protect from activation of a function not permitted a user during normal operation of the private branch exchange. FIG. 4 is a flow chart showing such a control.

Upon detecting a request for performing a function, during controlling the operation of the private branch exchange, the CPU 52 reads out the data of the PLD 51 (Steps S401 and S402). Then, the CPU 52 recognizes marked functions in the corresponding line of the data read out from the PLD 51, in the function comparison table 60 (Step S403). It is checked whether the requested function is included in the marked functions in the table 60 (Step S404).

When it is included therein, the CPU 52 runs the program for performing the function (Step S405). When it is not included, the requested function is neglected. Namely, the function that is requested will not be performed.

For example, assume that a user or a customer engineer operates a private branch exchange, which the functions #1, #3, and #4 are permitted as shown in FIG. 2, into the possible state of the “automatic call distribution” function. Since the PLD 51 in the system of this user is programmed so to supply the data “01”, the CPU 52 checks the line corresponding to the data “01” in the function comparison table 60. Since there is no “available” mark on the “automatic call distribution”, the CPU 52 neglects the operation for making the “automatic call distribution” function into possible state.

As mentioned above, even in the event that there arises a request for performing some function, during the operation of a private branch exchange, the CPU 52 is enabled to check whether the request is to be performed or not, according to the output data of the PLD 51. This can prevent execution of any function not permitted a user without fail.

Although the above embodiment has been described in the case where the present invention is applied to a private branch exchange, by way of only one example, the present invention can be applied to any system (electronic equipment) that operates according to a program. As apparent from the above-mentioned description, the present invention is more effective in such a system having various optional functions.

For example, the present invention may be applied to a general personal computer, thereby selecting functions required by a user by every product. It is also possible to apply the present invention to household electronic equipment. For example, a recent video abounds with many functions, which is troublesome for a user needing no special function. By the application of the present invention to such a video, functions can be selected according to the request of a user.

Although the above mentioned embodiments have been described, by way of example, in the case where all programs for performing all the functions are stored in the ROM 53, the present invention is applicable to a system designed to load each program from an external storing medium such as CD-ROM or the like into an internal hard disk or a nonvolatile semiconductor memory at the initial setting.

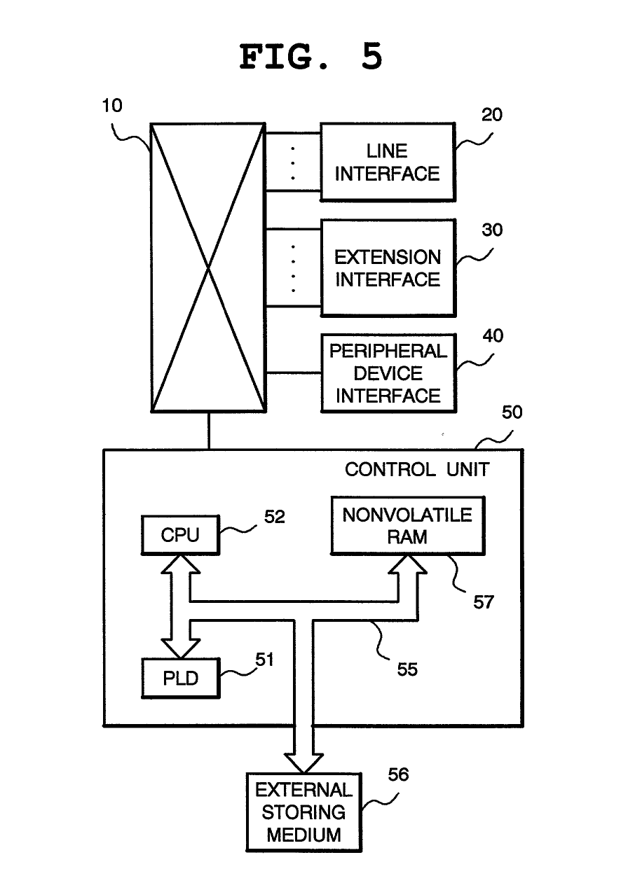

FIG. 5 shows an example of a private branch exchange provided with an external storing medium 56 such as CD-ROM or the like including the programs for performing all the functions, instead of the ROM 53 of the private branch exchange shown in FIG. 1 and designed to load only the program for performing a function in accordance with the output data of the PLD 51 from the external storing medium 56 into a nonvolatile RAM 57 that is a nonvolatile semiconductor memory.

As set forth hereinabove, since the present invention is adopted to design a system operating according to a program so as to run only the program for performing a function in accordance with the function selection data, it is possible to perform a function desired by a user with ease.

Since having a storing medium with the programs corresponding to all the possible functions stored therein, it is designed to run only the program for performing a function in accordance with the function selection data, of all the programs within the storing medium, it is possible to add a function with no need of change or addition of any software or hardware.

When the selection data storing circuit is a PLD, it has such an effect that it is possible for a provider to easily change the functions of a system and it is impossible for a user to easily change the functions.

When the PLD has a security bit, it is difficult to illegally create a PLD for the purpose of realizing a function different from the functions permitted a user or a function added to the functions permitted a user.

According to the present invention, in the event that there arises a request for performing some function, the function selection data is read out; when no requested function is found in the functions corresponding to the read out function selection data, the requested function cannot be performed. It is possible to check whether the requested function is to be performed or not every time there arises a request for performing a function, thereby preventing from unnecessary execution of a function that is not permitted a user without fail.

According to the function selection method of the present invention, it is possible to perform the function desired by a user easily with no need of change or addition of software or hardware in adding a function, by installing into a system, the software for selecting a program for performing a function in accordance with the output data of the PLD, and programming the PLD so to supply the data for specifying a function to be performed by the system before installing the programmed PLD into the system.

When changing a function to be performed, a PLD programmed so to supply the data for specifying the changed function is newly installed into a system, which makes it easy to change a function of a system.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A system for performing various functions according to an installed program, comprising:
selecting data storing means for storing function selecting data indicating kind of each function to be performed by the program; and
control means for making only a program for performing a function indicated in the function selecting data stored in said selecting data storing means, into executable state.

2. A system as set forth in claim 1, wherein
the function selecting data is data for specifying one of combinations of functions to be performed by the program,
relationship storing means for storing relationship between each function selecting data and each function indicated by the same data is included, and
said control means selects the function corresponding to the function selecting data of said selecting data storing means from said relationship storing means and makes only the program for performing the selected function into executable state.

3. A system as set forth in claim 1, further comprising:
program storing means for storing programs corresponding to all the possible functions to be performed,
said control means making only a program for performing a function indicated in the function selecting data, of the programs within said program storing means, into executable state.

4. A system as set forth in claim 1, further comprising:
program storing means for storing programs corresponding to all the possible functions to be performed,
the function selecting data being data for specifying one of combinations of functions to be performed by the program; and
relationship storing means for storing relationship between each function selecting data and each function indicated by the same data,
said control means selecting the function corresponding to the function selecting data of said selecting data storing means from said relationship storing means and making only the program for performing the selected function, of the programs within said program storing means, into executable state.

5. A system as set forth in claim 1, wherein
said selecting data storing means is a PLD installed in a replaceable way.

6. A system as set forth in claim 1, wherein
said selecting data storing means is a PLD,
program storing means for storing programs corresponding to all the possible functions to be performed is included, and
said control means makes only a program for performing a function indicated in the function selecting data of the PLD, of the programs within said program storing means, into executable state.

7. A system as set forth in claim 1, wherein
said selecting data storing means is a PLD having a security bit and installed in a replaceable way.

8. A system as set forth in claim 1, wherein
when there arises a request for performing a function, said control means reads out the function selecting data from said selecting data storing means, checks whether the requested function is found in the functions corresponding to the read-out function selecting data, and when the requested function is found there, the requested function is performed, while when it is not found, the requested function is not performed.

9. A system as set forth in claim 1, further comprising:
external storing means for storing programs corresponding to all the possible functions,
said control means loading only a program for performing a function indicated in the function selecting data, of the programs within said external storing means, from said external storing means so to make the program into executable state.

10. A function selecting method in a system for performing various functions according to an installed program, comprising the steps of:
installing a PLD in which function selecting data indicating kind of each function to be performed by the program is programmed, in a replaceable way; and
selecting a program for performing a function in accordance with the function selecting data of the PLD.

11. A function selecting method as set forth in claim 10, further comprising:
a step of newly installing a PLD in which the function selecting data for specifying the changed function is programmed, when changing the kind of a function to be performed.

12. A function selecting method as set forth in claim 10, further comprising:
a step of installing a control circuit for selecting a program for performing a function in accordance with the function selecting data of the PLD and making the same program into executable state.

13. A function selecting method as set forth in claim 10, further comprising:
a step of installing a control circuit for selecting a program for performing a function in accordance with the function selecting data of the PLD and making the same program into executable state, said method in which
said control circuit
reads out the function selecting data from said selecting data storing means when there arises a request for performing a function and checks whether the requested function is found in the functions corresponding to the read out function selecting data;
when the requested function is found there, the same requested function is performed, while when the requested function is not found, the same function is not performed.

14. A system for performing various functions according to an installed program, comprising:
a PLD, installed in a replaceable way, for storing function selecting data indicating kind of each function to be performed by the program; and
a control circuit for making only a program for performing a function indicated in the function selecting data stored in said PLD, into executable state.

15. A system as set forth in claim 14, wherein
the function selecting data is data for specifying one of combinations of functions to be performed by the program,
a relationship storing circuit for storing relationship between each function selecting data and each function indicated by the same data is included, and
said control circuit selects the function corresponding to the function selecting data of said PLD from said relationship storing circuit and makes only the program for performing the selected function into executable state.

16. A system as set forth in claim 14, further comprising:
a program storing circuit for storing programs corresponding to all the possible functions to be performed,
said control circuit making only program for performing a function indicated in the function selecting data, of the programs within said program storing means, into executable state.

17. A system as set forth in claim 14, further comprising:
a program storing circuit for storing programs corresponding to all the possible functions to be performed,
the function selecting data being data for specifying one of combinations of functions to be performed by the program; and
a relationship storing circuit for storing relationship between each function selecting data and each function indicated by the same data,
said control circuit selecting the function corresponding to the function selecting data of said PLD from said relationship storing circuit and making only the program for performing the selected function, of the programs within said program storing circuit, into executable state.

18. A system as set forth in claim 14, wherein said PLD has a security bit.

19. A system as set forth in claim 14, wherein when there arises a request for performing a function, said control circuit reads out the function selecting data from said PLD, checks whether the requested function is found in the functions corresponding to the read-out function selecting data, and when the requested function is found there, the requested function is performed, while when it is not found, the requestted function is not performed

20. A system as set forth in claim 14, further comprising:
an external storing medium for storing programs corresponding to all the possible functions,
said control circuit loading only a program for performing a function indicated in the function selecting data, of the programs within said external storing medium, from said external storing medium, so to make the same program into executable state.
